(19) United States
(12) Patent Application Publication
(10) Pub. No.: US 2024/0104976 A1
(43) Pub. Date: Mar. 28, 2024

(54) PROPOSAL DEVICE AND PROPOSAL SYSTEM

(71) Applicant: TOYOTA JIDOSHA KABUSHIKI KAISHA, Toyota-shi (JP)

(72) Inventor: Hiroaki SUTO, Toyota-shi (JP)

(21) Appl. No.: 18/467,836

(22) Filed: Sep. 15, 2023

(30) Foreign Application Priority Data
Sep. 28, 2022 (JP) 2022-155299

(51) Int. Cl. G07C 5/08

(52) U.S. Cl. CPC G07C 5/0816; G07C 5/0808

(57) ABSTRACT

A proposal device is provided, the proposal device including: a memory; and a processor coupled to the memory, the processor being configured to: acquire, from a vehicle, status information related to a state of the vehicle and a state of an onboard device, perform diagnosis of a trend in operation of the onboard device by a driver of the vehicle, based on the acquired status information, and propose, to the driver, introduction of an application that provides notification of a forgotten operation, in a case in which results of the diagnosis indicate a tendency by the driver to forget to operate the onboard device.

### CROSS-REFERENCE TO RELATED APPLICATION

This application is based on and claims priority under 35 USC 119 from Japanese Patent Application No. 2022-155299 filed on Sep. 28, 2022, the disclosure of which is incorporated by reference herein.

### BACKGROUND

### Technical Field

The present disclosure relates to a proposal device and a proposal system.

### Related Art

Japanese Patent Application (Laid-open) No. 2008-137556 discloses a forgotten action report device that reports that there is a slight possibility of forgetting to cancel the operation of an onboard electronic device.

With respect to a “connected car” equipped with an onboard unit that is capable of communicating with an external server or the like, it is possible to introduce an application provided with functionality similar to the forgotten action report device described in Japanese Patent Application (Laid-open) No. 2008-137556. However, if a driver who does not need this application introduces this application to an onboard unit of a vehicle in which the driver is riding, onboard unit resources are subjected to pressure, which is undesirable.

### SUMMARY

Accordingly, the present disclosure provides a proposal device and a proposal system capable of inhibiting resource constriction of an onboard unit of a vehicle.

A proposal device according to a first aspect of the present disclosure includes: an acquisition unit configured to acquire, from a vehicle, status information related to a state of the vehicle and a state of an onboard device, a diagnosis unit configured to perform diagnosis of a trend in operation of the onboard device by a driver of the vehicle, based on the status information acquired by the acquisition unit, and a proposal unit configured to propose, to the driver, introduction of an application that provides notification of a forgotten operation, in a case in which results of the diagnosis by the diagnosis unit indicate a tendency by the driver to forget to operate the onboard device.

In the proposal device according to the first aspect, an acquisition unit acquires the status information. Moreover, based on the status information acquired by the acquisition unit, a diagnosis unit diagnoses trends in operation of the onboard device by the driver of the vehicle. Moreover, in a case in which results of the diagnosis by the diagnosis unit indicate a tendency by the driver to forget to operate the onboard device, a proposal unit proposes, to the driver, introduction of an application that provides notification of a forgotten operation. As a result, according to the proposal device, since the introduction of this application is proposed to the driver in cases in which the results of the diagnosis indicate that the driver tends to forget to operate the onboard equipment, resource constriction of the onboard unit of the vehicle may be mitigated.

In the first aspect, the acquisition unit may acquire the status information from plural vehicles, the diagnosis unit, based on operation of the onboard device by plural drivers of the plural vehicles from the status information acquired by the acquisition unit, may diagnose a trend in operation of the onboard device by a single driver of a single vehicle, and in a case in which the results of the diagnosis performed by the diagnosis unit indicate a tendency by the single driver to forget to operate the onboard device, the proposal unit may propose introduction of the application to the single driver.

In the configuration described above, the acquisition unit acquires status information from plural vehicles. Further, in consideration of operation of onboard devices by plural drivers from the status information acquired by the acquisition unit, the diagnosis unit diagnoses trends in operation of the onboard device by a single driver. Further, in cases in which the results of the diagnosis performed by the diagnosis unit indicate a tendency by the single driver to forget to operate the onboard device, the proposal unit proposes introduction of an application to the single driver. As a result, according to the proposal device, proposals may be made in consideration of a tendency for plural drivers to forget to operate onboard devices.

In the first aspect, the acquisition unit may acquire plural types of the status information from a single vehicle, and the diagnosis unit may, in consideration of operation of plural onboard devices by a driver of the single vehicle from the plural types of status information acquired by the acquisition unit, diagnose trends in operation of an onboard device by the single driver.

In the configuration described above, the acquisition unit acquires plural types of status information from a single vehicle. Further, in consideration of operation of plural onboard devices by a single driver from the plural types of status information acquired by the acquisition unit, the diagnosis unit diagnoses trends in operation of the onboard device by a single driver. As a result, according to the proposal device, proposals may be made in consideration of a tendency for operation of plural onboard devices to be forgotten.

In the first aspect, the diagnosis unit may be configured to exclude, from a target of the diagnosis, status information that matches a preset condition.

In the configuration described above, the diagnosis unit excludes status information that matches a preset condition from the diagnostic target. For example, in a case in which a side mirror included in an onboard device is closed during travel of the vehicle, there is a tendency for operation of the onboard device to be forgotten; however, according to the proposal device, if the vehicle speed is below a predetermined value in the above-described case, by excluding corresponding status information from the diagnostic target, erroneous determination of forgotten operation of the onboard device may be reduced.

A proposal system according to a second aspect of the present disclosure includes the proposal device of the first aspect, and an onboard unit that is installed in the vehicle, that is configured communicatively with the proposal device, and that collects the status information.

As explained above, the proposal device and the proposal system according to the present disclosure may mitigate resource constriction of an onboard unit of a vehicle.

### BRIEF DESCRIPTION OF THE DRAWINGS

FIG. 1 is a diagram illustrating a schematic configuration of a proposal system.

FIG. 2 is a block diagram illustrating a hardware configuration of a proposal device.

FIG. 3 is a block diagram illustrating a schematic configuration of a vehicle.

FIG. 4 is a flow chart illustrating a flow of proposal processing.

FIG. 5 is a display example displayed on a monitor included in an onboard device.

### DETAILED DESCRIPTION

Explanation follows regarding the proposal system 10 according to the present exemplary embodiment. The proposal system 10 according to the present exemplary embodiment is a system that inhibits resource constriction of an integrated electrical control unit (ECU) 50 of a vehicle 40.

### First Exemplary Embodiment

First, explanation follows regarding a first exemplary embodiment of the proposal system 10 according to the present exemplary embodiment.

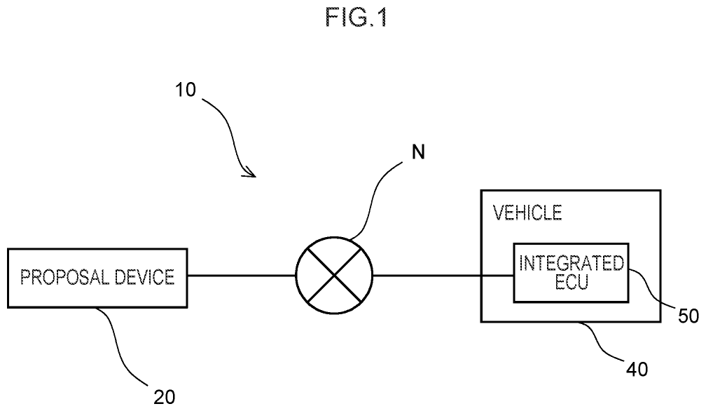

FIG. 1 is a diagram illustrating a schematic configuration of the proposal system 10. As illustrated in FIG. 1, the proposal system 10 includes a proposal device 20 and a vehicle 40. The proposal device 20 and the integrated ECU 50 installed in the vehicle 40 are connected through a network N. The integrated ECU 50 is an example of an onboard unit.

The proposal device 20 may be a server computer retained by a predetermined business operator. While the vehicle 40 may be an engine vehicle, a hybrid vehicle, or an electric vehicle, in the present exemplary embodiment, as an example, the vehicle 40 is an engine vehicle.

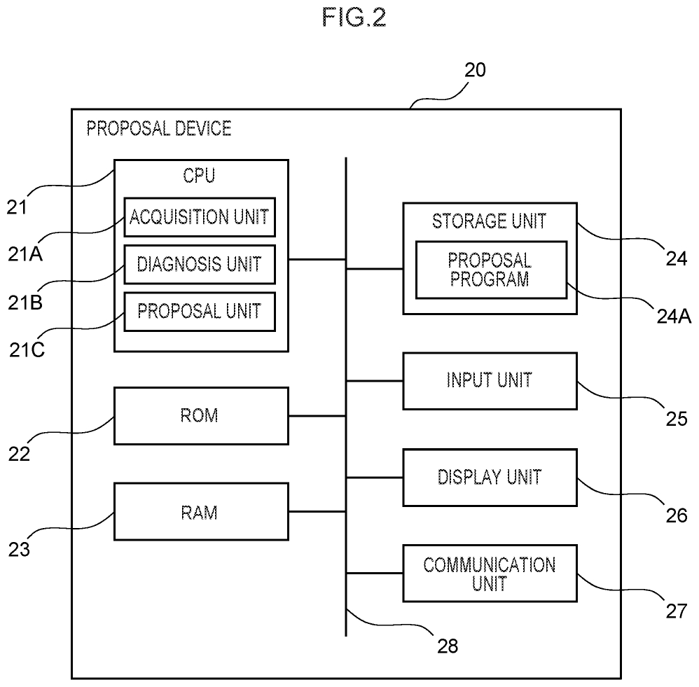

Next, explanation follows regarding a hardware configuration of the proposal device 20. FIG. 2 is a block diagram illustrating a hardware configuration of the proposal device 20.

As illustrated in FIG. 2, the proposal device 20 includes a central processing unit (CPU) 21, read only memory (ROM) 22, random access memory (RAM) 23, a storage unit 24, an input unit 25, a display unit 26, and a communication unit 27. The respective configurations are connected through a bus 28 so as to be capable of communicating with each other.

The CPU 21 is a central processing unit that executes various programs and controls various units. Namely, the CPU 21 reads a program from the ROM 22 or the storage unit 24, and executes the program using the RAM 23 as a workspace. The CPU 21 controls the respective configurations and performs various computation processing according to a program stored in the ROM 22 or the storage unit 24.

The ROM 22 holds various programs and various data. The RAM 23 serves as a workspace to temporarily store programs and data.

The storage unit 24 is configured by a storage device such as a hard disk drive (HDD), a solid state drive (SSD), or flash memory, and holds various programs and various data. The storage unit 24 holds a proposal program 24A for causing the CPU 21 to execute proposal processing, described below.

The input unit 25 includes a pointing device such as a mouse, a keyboard, a microphone, a camera, and the like, and is used to perform various inputs.

The display unit 26 is, for example, a liquid crystal display, and displays various information. The display unit 26 may employ a touch panel method to function as the input unit 25.

The communication unit 27 is an interface for communicating with other devices. For example, a wired communication standard such as Ethernet® or FDDI, or a wireless communication standard such as 4G, 5G, Bluetooth®, or Wi-Fi® is used for this communication. The communication unit 27 is connected to the network N.

Next, explanation follows regarding the functional configuration of the proposal device 20. As illustrated in FIG. 2, the CPU 21 of the proposal device 20 includes an acquisition unit 21A, a diagnosis unit 21B, and a proposal unit 21C as functional configuration. The respective functional configurations are implemented by the CPU 21 reading out and executing the proposal program 24A stored in the storage unit 24.

The acquisition unit 21A acquires, from the vehicle 40, status information relating to the state of the vehicle 40 and the state of an onboard device 65, described below. As an example, the status information includes information indicating whether the vehicle 40 is traveling—specifically, whether or not the vehicle 40 is moving straight, on a curve, turning right or left, or the like—or whether the vehicle 40 is stationary or parked. Moreover, the status information includes information indicating whether or not the onboard device 65 is active or not in operation, as a state of the onboard device 65.

Based on the status information acquired by the acquisition unit 21A, the diagnosis unit 21B diagnoses a trend of operation of the onboard device 65 by a driver of the vehicle 40. As an example, the diagnosis unit 21B diagnoses whether or not there is a tendency for operation of the onboard device 65 to be forgotten as a trend of operation of the onboard device 65. Forgetting to operate the onboard device 65 includes failure to activate the onboard device 65 when, for example, a winker switch included in the onboard device 65 is not in operation during a right or left turn of the vehicle 40, and failure to stop the onboard device 65 when, for example, a winker switch or a hazard lamp included in the onboard device 65 is being operated while the vehicle 40 is traveling straight. In a case in which the relevant number of forgotten operations of the onboard device 65 exceeds a predetermined number per unit time, a diagnosis is made that the driver tends to forget to operate the onboard device 65.

Moreover, the diagnosis unit 21B excludes status information that matches a preset condition from the diagnosis target. Examples for such status include a case in which a side mirror included in the onboard device 65 is closed while the vehicle 40 is traveling, but the vehicle speed is less than or equal to a predetermined value, and a case in which although a hazard lamp included in the onboard device 65 is operating during travel of the vehicle 40, the operation time is equal to or less than a predetermined time.

The proposal unit 21C, as a result of the diagnosis performed by the diagnosis unit 21B, in cases in which the driver tends to forget to operate the onboard device 65, proposes, to the driver, the introduction of an application (hereafter referred to as a “notification application”) that provides notification of a forgotten operation of the onboard device 65. For example, the proposal unit 21C transmits a predetermined notification recommending the introduction of the notification application to the vehicle 40 as the proposal. The vehicle 40 that receives the notification then reports the content indicated by the notification through a monitor, speaker, or the like included in the onboard device 65. This enables introduction of the notification application to be proposed to the driver.

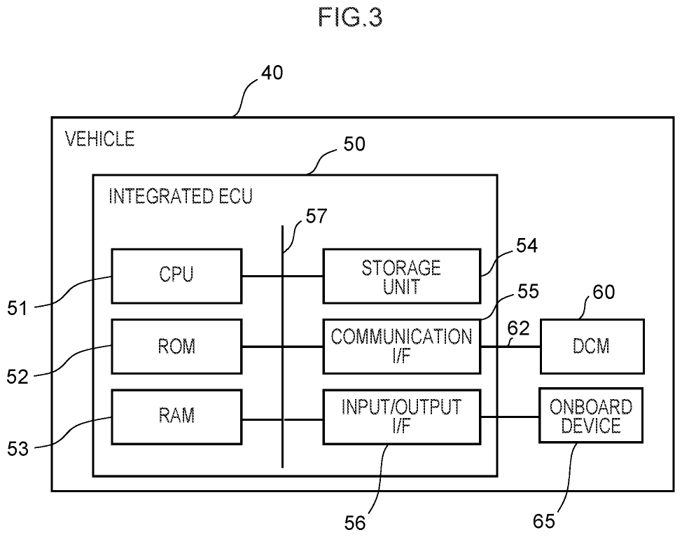

Next, explanation follows regarding a schematic configuration of the vehicle 40. FIG. 3 is a block diagram illustrating a schematic configuration of the vehicle 40.

As illustrated in FIG. 3, the vehicle 40 includes an integrated ECU 50, a data communication module (DCM) 60, and an onboard device 65. The ECU included in the vehicle 40 is not limited to the integrated ECU 50, and includes plural non-illustrated ECUs corresponding to the respective functions of the vehicle 40.

The integrated ECU 50 and the DCM 60 are connected through an external bus (communication bus) 62. The external bus 62 performs Ethernet (registered trademark) communication. Note that the communication method of the external bus 62 is not limited to the Ethernet (registered trademark), and a controller area network (CAN) protocol, a CAN with flexible data rate (CAN-FD), or the like may be applied.

The DCM 60 is connected to the network N so as to be capable of communicating with the outside. The communication is wireless communication, and for example, a communication standard such as 5G, LTE, or Wi-Fi (registered trademark) is used.

The integrated ECU 50 is configured including a CPU 51, a ROM 52, a RAM 53, a storage unit 54, a communication interface (I/F) 55, and an input/output I/F 56. The CPU 51, the ROM 52, the RAM 53, the storage unit 54, the communication I/F 55, and the input/output I/F 56 are connected so as to be capable of communicating with each other through an internal bus 57.

The CPU 51 is a central processing unit that executes various programs and controls various units. Namely, the CPU 51 reads a program from the ROM 52 or the storage unit 54, and executes the program using the RAM 53 as a workspace. The CPU 51 controls the respective configurations and performs various computation processing according to a program recorded in the ROM 52 or the storage unit 54.

The ROM 52 holds various programs and various data. The RAM 53 serves as a workspace to temporarily store programs and data.

The storage unit 54 is a NAND memory configured by an embedded multi media card (eMMC), universal flash storage (UFS), or the like.

The respective components included in the integrated ECU 50, such as the ROM 52 and the storage unit 54, are preferably tamper-resistant media such as a hardware security module (HSM).

The communication I/F 55 is an interface for connecting to the DCM 60. The interface employs a communication protocol based on the Ethernet (registered trademark). The communication I/F 55 is connected to the external bus 62.

The input/output I/F 56 is an interface for communicating with the onboard device 65. Note that there is no limitation thereto, and the onboard device 65 may be connected through another ECU. In this case, the integrated ECU 50 and other ECUs are connected by the Ethernet®, a CAN protocol, or the like.

The integrated ECU 50 collects status information from the onboard device 65 through the input/output I/F 56, and causes the collected status information to be stored in the storage unit 54. The integrated ECU 50 periodically transmits the status information stored in the storage unit 54 to the proposal device 20.

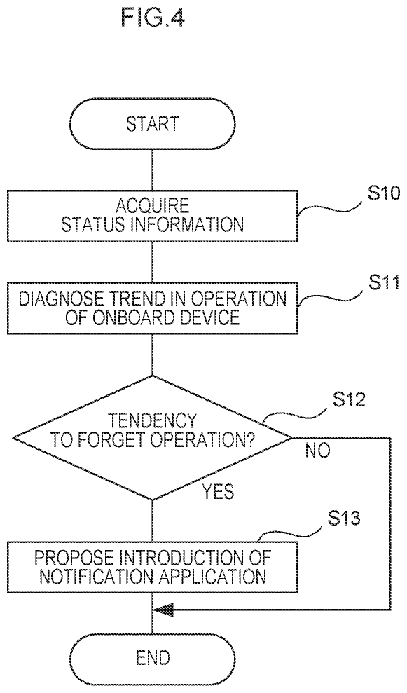

FIG. 4 is a flowchart illustrating a flow of proposal processing performed by the proposal device 20 to suggest, to a driver, that a notification application be introduced in a case in which the driver tends to forget to operate the onboard device 65. The proposal processing is performed by the CPU 21 reading, from the storage unit 24, the proposal program 24A, and opening and executing the program in the RAM 23.

At step S10 illustrated in FIG. 4, the CPU 21 acquires status information from the vehicle 40. Then, the flow advances to step S11.

At step S11, the CPU 21 diagnoses trends in operation of the onboard device 65 by the driver of the vehicle 40 based on the status information acquired at step S10. The flow then advances to step S12.

At step S12, the CPU 21 determines whether or not it has been diagnosed at step S11 that the driver has a tendency to forget to operate the onboard device 65, and in a case in which it has been diagnosed that there is a tendency for operation to be forgotten (step S12: YES), the processing proceeds to step S13. On the other hand, in a case in which the CPU 21 has not diagnosed at step S11 that there is a tendency for the driver to forget to operate the onboard device 65 (step S12: NO), the proposal processing is ended.

At step S13, the CPU 21 proposes to the driver that the notification application be introduced. Then, the proposal processing is ended.

Next, explanation follows regarding an example of content proposed to a driver relating to introduction of a notification application.

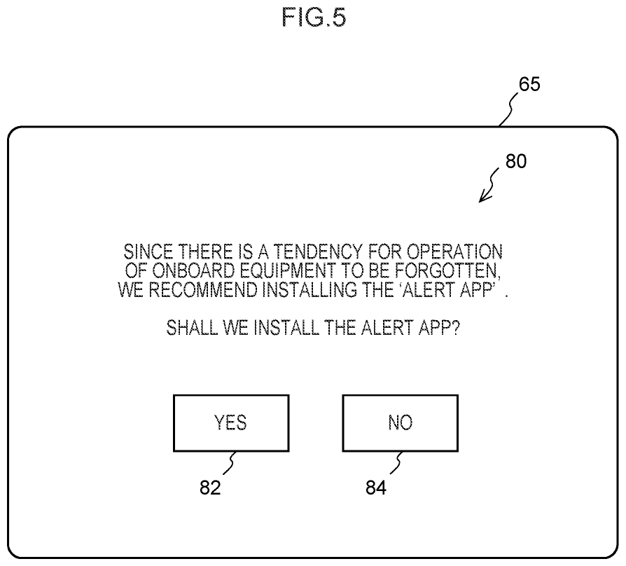

FIG. 5 is an example of a display displayed on a monitor included in the onboard device 65. As an example, in a case in which a predetermined notification, transmitted from the proposing device 20, that recommends the introduction of the notification application has been received, the integrated ECU 50 displays the screen illustrated in FIG. 5 on the monitor based on the turning on of the ignition switch included in the onboard device 65.

In the display example illustrated in FIG. 5, message information 80, a YES button 82, and a NO button 84 are displayed.

The message information 80 indicates various messages to the driver. As an example, in FIG. 5, as the message information 80, the following is displayed: “Since there is a tendency for operation of onboard equipment to be forgotten, we recommend installing the ‘Alert App’. Shall we install the Alert App?” In a case in which the YES button 82 has been operated, the integrated ECU 50 starts introducing the notification application. In a case in which the NO button 84 has been operated, the integrated ECU 50 changes the display content of the monitor to predetermined content without introducing the notification application.

As described above, in the first exemplary embodiment, the CPU 21 acquires status information. Moreover, based on the acquired status information, the CPU 21 diagnoses trends in operation of the onboard device 65 by a driver of the vehicle 40. Moreover, as a result of the diagnosis, in a case in which the driver tends to forget to operate the onboard device 65, the CPU 21 suggests to the driver that the notification application be introduced. As a result, according to the proposal device 20 of the first exemplary embodiment, since, as a result of the diagnosis, the introduction of a notification application is proposed to the driver in cases in which the driver tends to forget to operate the onboard device 65, this enables resource constriction of the integrated ECU 50 of the vehicle 40 to be inhibited.

In the first exemplary embodiment, the CPU 21 excludes status information that matches a preset condition from the diagnosis target. For example, in a case in which a side mirror included in the onboard device 65 is closed during travel of the vehicle 40, although this might be presumed to indicate a tendency for operation the onboard device 65 to be forgotten, according to the proposal device 20 of the first exemplary embodiment, if the vehicle speed is below a predetermined value in the above-described case, by excluding corresponding status information from the diagnostic target, erroneous determination of forgotten operation of the onboard device 65 may be reduced.

### Second Exemplary Embodiment

Next, explanation follows regarding a second exemplary embodiment of the proposal system 10 according to the present exemplary embodiment, while omitting or simplifying areas of overlap with the above-described exemplary embodiment.

The acquisition unit 21A of the second exemplary embodiment acquires status information from plural vehicles 40.

Based on the status information acquired by the acquisition unit 21A, and in consideration of operation of onboard devices 65 by plural drivers of the plural vehicles 40 having similar characteristics to those of a single driver of a single vehicle 40, the diagnosis unit 21B of the second exemplary embodiment diagnoses trends in operation of the onboard device 65 by the single driver. These similar characteristics are similarities in age, gender, and vehicle type, for example. In the second exemplary embodiment, the storage unit 24 of the proposal device 20 stores driver information relating to each driver respectively input by the plural drivers. The driver information includes information indicating the age of the driver, the gender of the driver, the vehicle type of the vehicle 40 held by the driver, and the like. Then, the diagnosis unit 21B, based on the driver information stored in the storage unit 24, identifies plural drivers with similar characteristics to the relevant single driver.

Here, in cases in which the single driver has been diagnosed as having a tendency to forget to operate the onboard device 65 (e.g., a winker switch), the diagnosis unit 21B adds information indicating plural drivers who tend to forget to operate the onboard device 65 similarly to the single driver to the diagnosis result.

As a result of the diagnosis performed by the diagnosis unit 21B, in cases in which the single driver tends to forget to operate the onboard device 65, the proposal unit 21C of the second exemplary embodiment proposes introduction of a notification application to the single driver. In the second exemplary embodiment, the proposal unit 21C transmits a predetermined notification to the vehicle 40 in consideration of operation of the onboard device 65 by plural drivers having similar characteristics to a single driver. The vehicle 40 that receives the notification then reports the content indicated by the notification through a monitor, speaker, or the like included in the onboard device 65. While not illustrated in the drawings, the monitor of the vehicle 40 that has received this notification displays a message such as, “Since you often forget to turn off the winker switch, we recommend introducing a notification application.”

As described above, in the second exemplary embodiment, the CPU 21 acquires status information from plural vehicles 40. Moreover, the CPU 21 diagnoses trends in operation of the onboard device 65 by a single driver in consideration of operation of the onboard device 65 by plural drivers from the acquired status information. Moreover, as a result of the diagnosis, in a case in which the single driver tends to forget to operate the onboard device 65, the CPU 21 proposes the introduction of the notification application to the single driver. As a result, according to the proposal device 20 of the second exemplary embodiment, proposals may be made in consideration of a tendency by plural drivers to forget to operate the onboard device 65.

### Third Exemplary Embodiment

Next, explanation follows regarding a third exemplary embodiment of the proposal system 10 according to the present exemplary embodiment, while omitting or simplifying areas of overlap with the above-described exemplary embodiments.

The acquisition unit 21A of the third exemplary embodiment acquires plural types of status information from a single vehicle 40.

In the diagnosis unit 21B of the third exemplary embodiment, in consideration of operation of plural onboard devices 65 by a single driver of a single vehicle 40 from the plural types of status information acquired by the acquisition unit 21A, trends in operation of the onboard device 65 by the single driver are diagnosed. In the third exemplary embodiment, in cases in which forgotten operations of plural onboard devices 65 exceed a predetermined number per unit time, the diagnosis unit 21B diagnoses that the single driver tends to forget to operate the onboard device 65.

In the third exemplary embodiment, based on a result of the diagnosis performed by the diagnosis unit 21B, in a case in which there is a tendency for a single driver to forget to operate the onboard device 65, the proposal unit 21C transmits a predetermined notification to the vehicle 40 in consideration of the operation of the plural onboard devices 65 by the single driver. The vehicle 40 that receives the notification then reports the content indicated by the notification through a monitor, speaker, or the like included in the onboard device 65. Although not illustrated in the drawings, a message such as, “Since there have been frequent instances of failure to turn off the winker switch, hazard lamps, or the like, installation of a notification application is recommended” is displayed at the monitor of the vehicle 40 that received this notification.

As described above, in the third exemplary embodiment, the CPU 21 acquires plural types of status information from a single vehicle 40. The CPU 21 then, in consideration of the operation of plural onboard devices 65 by a single driver from the acquired plural types of status information, diagnoses trends in operation of the onboard devices 65 by the single driver. As a result, according to the proposal device 20 of the third exemplary embodiment, proposals may be made in consideration of tendencies for the operation of plural onboard devices 65 to be forgotten.

### Other Embodiments

In the above exemplary embodiments, in cases in which a tendency for the driver to forget to operate the onboard device 65 is not diagnosed—namely, in cases in which the driver does not tend to forget to operate the onboard device 65—the CPU 21 ends the proposal processing (see FIG. 4). However, there is no limitation thereto, and in cases in which the driver does not tend to forget to operate the onboard device 65, the CPU 21 may transmit a notification to the vehicle 40 indicating that there is no tendency for the driver to forget to operate the onboard device 65. In this case, by reporting the content indicated by the notification through a monitor, speaker, or the like included in the onboard device 65, the driver may be made aware that there is no tendency to forget to operate the onboard device 65.

Note that the proposal processing executed by the CPU 21 reading and executing software (a program) in the above exemplary embodiments may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The proposal processing may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

Although explanation has been given regarding an aspect in which the proposal program 24A is stored (installed) in advance in the storage unit 24 in the above exemplary embodiments, there is no limitation thereto. The proposal program 24A may be provided in a format recorded on a recording medium such as compact disc read only memory (CD-ROM), digital versatile disc read only memory (DVD-ROM), or universal serial bus (USB) memory. Alternatively, the proposal program 24A may be provided in a format downloadable from an external device over the network N.

What is claimed is:

1. A proposal device, comprising:
a memory; and
a processor coupled to the memory, the processor being configured to:
acquire, from a vehicle, status information related to a state of the vehicle and a state of an onboard device,
perform diagnosis of a trend in operation of the onboard device by a driver of the vehicle, based on the acquired status information, and
propose, to the driver, introduction of an application that provides notification of a forgotten operation, in a case in which results of the diagnosis indicate a tendency by the driver to forget to operate the onboard device.

2. The proposal device of claim 1, wherein the processor is further configured to:
acquire the status information from a plurality of the vehicles,
perform diagnosis of a trend in operation of the onboard device by a single driver of a single vehicle, based on operation of the onboard device by a plurality of drivers of the plurality of vehicles from the acquired status information, and
propose, to the single driver, introduction of the application, in a case in which results of the diagnosis indicate a tendency by the single driver to forget to operate the onboard device.

3. The proposal device of claim 1, wherein the processor is further configured to:
acquire a plurality of types of the status information from a single vehicle, and
perform diagnosis of a trend in operation of the onboard device by a single driver of a single vehicle, based on operation of a plurality of the onboard devices by the single driver from the acquired plurality of types of the status information.

4. The proposal device of claim 1, wherein the processor is further configured to exclude, from a target of the diagnosis, status information that matches a preset condition.

5. A proposal system, comprising:
the proposal device of claim 1; and
an onboard unit that is installed in the vehicle, that is configured communicatively with the proposal device, and that collects the status information.
